(19) United States
(12) Patent Application Publication
(10) Pub. No.: US 2013/0044187 A1
(43) Pub. Date: Feb. 21, 2013

(54) 3D CAMERA AND METHOD OF MONITORING A SPATIAL ZONE

(71) Applicants: Markus HAMMES, Waldkirch (DE); Stefan MACK, Waldkirch (DE)

(72) Inventors: Markus HAMMES, Waldkirch (DE); Stefan MACK, Waldkirch (DE)

(73) Assignee: SICK AG, Waldkirch (DE)

(21) Appl. No.: 13/588,651

(22) Filed: Aug. 17, 2012

(30) Foreign Application Priority Data
Aug. 18, 2011 (DE) 10 2011 052 802.4

(51) Int. Cl. H04N 13/02

(52) U.S. Cl. 348/46; 348/E13.074

(57) ABSTRACT

A 3D camera (10) for monitoring a spatial zone (12) is provided, wherein the 3D camera (10) has at least one image sensor (14a-b) for taking image data from the spatial zone (10), an evaluation unit (22, 24) for generating a distance image with three-dimensional image data from the image data of the image sensor (14a-b) and an illumination unit (100) with a light source (104) and an upstream microoptical array (106) with a plurality of microoptics (106a) to illuminate the spatial zone (12) with an irregular illumination pattern (20). In this respect, the light source (104) has a semiconductor array with a plurality of individual emitters (104a) and the microoptical array (106) has non-imaging microoptics (106a).

The invention relates to a 3D camera having an illumination unit and to a method of monitoring a spatial zone in accordance with the preamble of claim 1 and claim 15 respectively.

In contrast to a conventional camera, a 3D camera also takes depth information and thus generates three-dimensional image data which are also called a distance image or a depth map. The additional distance dimension can be utilized in a plurality of applications to gain more information on objects in the scenery detected by the camera.

One example for this is safety engineering. A typical application in safety technology is the securing of a dangerous machine such as a press or a robot where a securing takes place around the machine on an intrusion of a body part into a danger area. Depending on the situation, this can be the switching off of the machine or the bringing into a safe position. Three-dimensional protected zones can be defined by the additional depth information which can be adapted more exactly to the danger situation than two-dimensional protected fields and a better evaluation can also be made whether a person is approaching the danger source in a critical manner.

In a further application, detected movements are interpreted as a command to a control connected to the 3D camera. Gestures are, for example, detected for this purpose. Although this is primarily known from entertainment electronics, it can also be utilized to operate or configure a sensor in safety engineering such as described, for instance, in DE 10 2010 017 857.

A known principle for detecting three-dimensional image data is based on triangulation using the aid of an active pattern illumination. In stereoscopic systems, at least two shots are then respectively taken from different perspectives. Structures which are the same are identified in the overlapping image regions and distances are calculated from the disparity and from the optical parameters of the camera system by means of triangulation and thus a three-dimensional image or a depth map (disparity map) is calculated.

A stereo camera is in principle also able to work passively, i.e. without its own pattern illumination. However, there is the demand for a reliable image evaluation, very particularly within the framework of safety engineering, to generate the three-dimensional image data in the form of a dense depth map, that is to have available a reliable spacing value for each image zone to be evaluated and preferably for almost every picture element. If the scenery to be monitored is low in contrast or if it has zones with little structure, this is not achieved with a passive sensor. Large structure-less areas or structural features similar to one another can prevent a clear association of image areas on the location of correspondences between the structural elements of the images. As a consequence, there are gaps in the three-dimensional images or erroneous calculations of the distances.

Other triangulation systems only use one camera and evaluate the changes of the projected pattern by objects at different distances. For this purpose, the system is taught the illumination pattern and expectations are thus generated for the image data for different object distances and object structures. One possibility is to teach the illumination pattern on objects, in particular a surface, at different distances as a reference image. An active illumination is indispensable right from the start in such a system.

An illumination unit for a stereoscopic safety camera is known from EP 2 166 304 A1. In this respect, an irregular illumination pattern is generated with the aid of an optical phase element which is transilluminated by a divergent laser light source. The required intensities of the illumination pattern cannot be achieved in a desired range using such a phase element.

In US 2007/0263903 A1, a stereo camera system generates a structured illumination pattern by means of a lighting unit, the illumination pattern then being used to calculate distances. In this respect, the pattern arises in that a diffractive optical element is illuminated using a laser or an LED. It is problematic in the use of a diffractive optical element that a relatively large light portion is transmitted in the zeroth order of diffraction. For reasons of eye safety, this illumination unit can therefore not be operated with the required luminous intensities.

A second diffractive optical element is therefore disposed downstream in a similar arrangement in WO 2009/093228 A2. The light ray of the zeroth order of diffraction is again distributed in this manner.

The use of illumination units on the basis of diffractive optical elements, however, has the further disadvantage that the single-mode laser diodes with a very small emitting surface required as light sources for this purpose are only available with a relatively small output power well below one watt and only have a limited service life. This has a negative effect on the field of vision or field of view angle, on the range, on the exposure time and on the detection capability or availability. Such illumination units are thus in particular only usable with restrictions for illuminating larger zones at larger distances such as are required in application in safety engineering.

In another known approach, which is described in US 2008/0240502 A1 for example, a transparency generates a spot pattern for a 3D sensor. The use of a projection method using a transparency is, however, only of limited efficiency from an energy and thus economic standpoint. The dark regions of the illumination patterns are hard-shadowed and not redistributed in an energy-efficient manner so that the shadowed light only contributes to the heating and not to the illumination of the monitored zone. The lower the degree of filling of the pattern, that is the ratio of transmission area to total area of the transparency, the lower the efficiency also is. This has a particularly disadvantageous effect because a degree of filling of, for example, 10-20% is already sufficient for the detection of dense depth maps. 80-90% of the output power thus remains unused. This is not only inefficient in energy terms, but also drives manufacturing costs up because the price of laser diodes escalates in an approximately linear manner with the optical output power.

In accordance with US 2010/0118123 A1, a special transparency having a plurality of microlenses arranged in irregular manner is used. However, in practice this only results in an illumination pattern with sufficient contrast if a pinhole array is disposed downstream to exclude scattered light and similar interference effects. On use of a laser as a light source, mode masks are additionally required to achieve a sufficient beam quality. A very complex and expensive optical system thus becomes necessary overall.

It is therefore the object of the invention to improve the generation of an illumination pattern for a 3D camera.

This object is satisfied by a 3D camera and by a method of monitoring a spatial zone in accordance with claim 1 and claim 15 respectively. In this respect, the invention starts from the basic idea of redistributing the light of an illumination unit using a plurality of microoptics in order thereby to achieve an irregular illumination pattern. To avoid the disadvantages in the use of microlenses described above, non-imaging microoptics are then used in accordance with the invention to achieve the required irregular structure of the illumination pattern. Each of a plurality of individual emitters of the illumination unit generates a single light beam which forms a laterally offset virtual image of the individual emitter by deflection at an associated microoptics and a pattern element when incident on an object in the scenery.

In this respect, an irregular structure or an irregular arrangement of pattern elements is understand as one which causes no spurious correlations, or at least as few spurious correlations as possible, in the image evaluation. In the ideal case, the arrangement, and thus the illumination pattern, is irregular, that is, at least locally within the relevant correlation window, it cannot be transformed into itself by simple symmetry operations such as translations or rotations With stereo cameras, translations parallel to the stereo basis are primarily of relevance here, that is the connection axis of the projection centers of both cameras.

The invention has the advantage that illumination patterns can be generated with ideal light yield and with particularly high optical output power at high efficiency. At the same time, there is a high flexibility in the choice of the illumination pattern or specifically of the spot arrangement of the individual light beams of the individual emitters incident in the scenery. Different illumination patterns, for example for different range variants of the 3D camera, arise by means of different microoptical arrays using the same light source. A microoptical array is comparatively simple to manufacture.

The microoptical array is preferably a microprism array, with the non-imaging microoptics being designed as prisms which deflect the light beams of the individual emitters in respective different directions. Such microprism fields can be manufactured very simply by a stamping process. The beam lobes of the individual beams of the individual emitters are deflected separately by the prisms.

The prisms furthermore preferably have a Fresnel structure. The geometry of the microprism field can thus be influenced by structuring the prisms, for example a thickness can be reduced.

The prisms are preferably designed mutually different and thus transmit incident light beams at different deflection angles. A greater freedom thus arises to design the resulting illumination pattern and the structure of the illumination patterns does not depend only on the arrangement of the prisms within the microoptical array. If alternatively prisms with uniform deflection angles are used, the prisms must necessarily be arranged irregularly on the microoptical array to achieve an irregular illumination pattern.

The microoptics are preferably arranged irregularly. As just described, the irregularity of the illumination patterns could also be achieved solely by different deflection angles of the individual microoptics. There are, however, additional adjustable screws for the structure of the illumination pattern due to an irregular arrangement.

The individual emitters are arranged irregularly in an alternative embodiment. Such an emitter array is complex and/or expensive to manufacture in comparison with an irregular microoptical array. There are then three different starting points to generate an irregular illumination pattern: The arrangement of the individual emitters, the arrangement of the microoptics and the design of the individual microoptics, in particular their deflection angles. These three variation possibilities can be used individually or in combination.

The semiconductor array is preferably a VCSEL (vertical cavity surface emitting laser) array. The desired arrangement of the individual emitters of the VCSEL array is achieved by the irregular mask for the emitter surfaces. Since hardly anything of the original starting power is lost due to the arrangement in accordance with the invention, VCSEL arrays with moderate total powers of some watts are sufficient, with naturally VCSEL arrays with higher powers, in particular for very large ranges, also being able to be used.

The semiconductor array preferably has a large number of at least a thousand, ten thousand or a hundred thousand individual emitters. Such semiconductor arrays are available comparatively inexpensively in the form of VCSEL arrays, for example. The large number of individual emitters with a correspondingly high number of pattern elements in the illumination pattern results in an illumination pattern with a sufficiently fine structure to ensure a high resolution of the 3D camera.

Each individual emitter preferably has a dot-shaped radiation surface and the pattern element generated by the individual emitter has the form of the radiation surface. A spot pattern thus arises in which each pattern element is a spot generated by an individual emitter, with this naturally not being understood as dimensionless in the strict geometrical sense. The spot has a specific finite extent and should also have this to be detected by the image sensor.

The individual emitters preferably form at least two groups, with one group of individual emitters being activatable without activating the other groups of individual emitters. It is thus possible to switch between different patterns which arise by a respective group or by a combination of a plurality of groups. In the borderline case, each individual emitter forms its own group and is thus selectively actuable. If the semiconductor array is formed with a higher packing density of individual emitters than is necessary for the illumination, the activation of subsets also effects a sufficient illumination. An adaptive adaptation of the illumination pattern to the scenery present is then made possible by a direct choice of such subsets or group combinations.

The individual emitters can preferably be controlled by mutually different currents. This can be achieved, for example, by different resistances or different thicknesses of the feed lines. The individual pattern elements are differently bright due to the power gradients introduced in this manner. This can also be utilized for adaptation to a scenery. A case of general interest is the compensation of marginal loss. This is a disadvantageous effect of optics or of image sensors which result in irregularly illuminated images with darker margins. This is compensated in that the individual emitters can preferably be controlled with higher currents in an outer region of the semiconductor array than individual emitters in an inner region of the semiconductor array. The local brightness distribution of the illumination pattern can thus be adapted via the selection of the electrode on the semiconductor array of the light source and via a setting of the local current flow and thus a separate homogenization of the brightness can also be dispensed with.

The illumination unit preferably has an imaging objective to project the illumination pattern into the spatial zone. A single lens is sufficient as the imaging objective in the simplest case. The imaging objective can, however, also be formed as reflective instead of refractive. The individual emitters do not have to generate the pattern element in the far field of the spatial zone thanks to the imaging objective, but the pattern is rather picked up shortly behind the pattern generation element and is projected into the spatial zone. The imaging objective compensates the divergence of the individual emitters which increases with a smaller radiation surface.

The imaging objective and the semiconductor array are preferably arranged displaceable with respect to one another to image different subsets of individual emitters. A respective different region of the semiconductor array is utilized in this respect to generate the illumination pattern in order thus to enable an adaptation to the scenery.

The 3D camera is preferably formed as a stereo camera, with the evaluation unit having a stereoscopy evaluation unit which is designed for the application of a stereo algorithm in which mutually associated part regions of the images of the spatial zone illuminated by the illumination pattern and taken by the two cameras of the stereo camera are recognized and their distance is calculated with reference to the disparity to generate a three-dimensional distance image. The contrast in the scenery increased in accordance with the invention in this respect helps also to detect dense depth maps with an unfavorable scenery.

The 3D camera is preferably designed as a safety camera, with the evaluation unit being designed to recognize unpermitted intrusions into the spatial zone and thereupon to generate a switch-off signal and with a safety output being provided to output a switch-off signal via it to a monitored machine. A reliable detection of a dense depth map is particularly necessary for safety engineering applications. The required secure object detection is thereby made possible.

The method in accordance with the invention can be further developed in a similar manner and shows similar advantages in so doing. Such advantageous features are described in an exemplary, but not exclusive, manner in the subordinate claims dependent on the independent claims.

The invention will be explained in more detail in the following also with respect to further features and advantages by way of example with reference to embodiments and to the enclosed drawing. The Figures of the drawing show in:

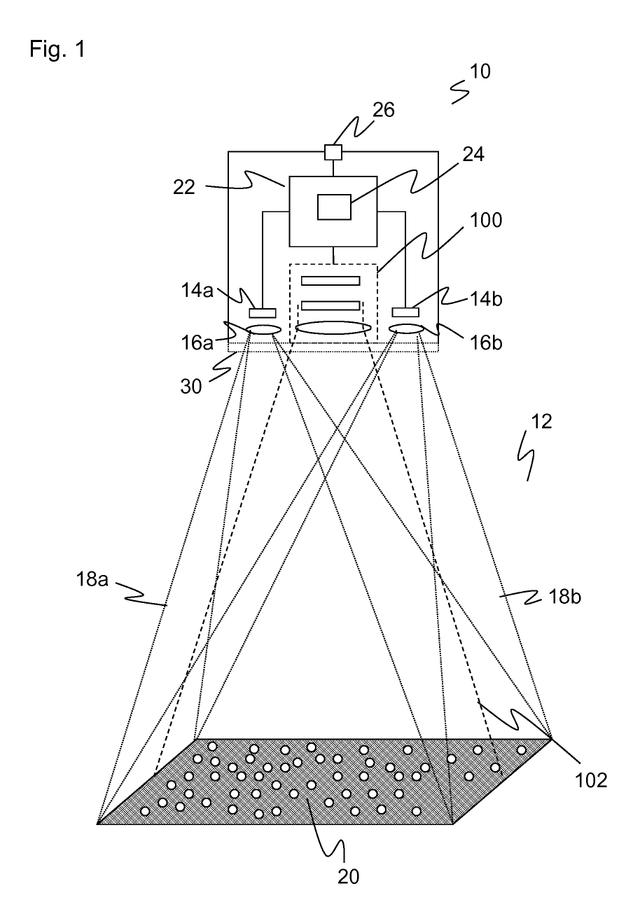

FIG. 1 a schematic overall representation of an embodiment of a 3D camera in accordance with the invention with the spatial zone illuminated by its illumination unit; and

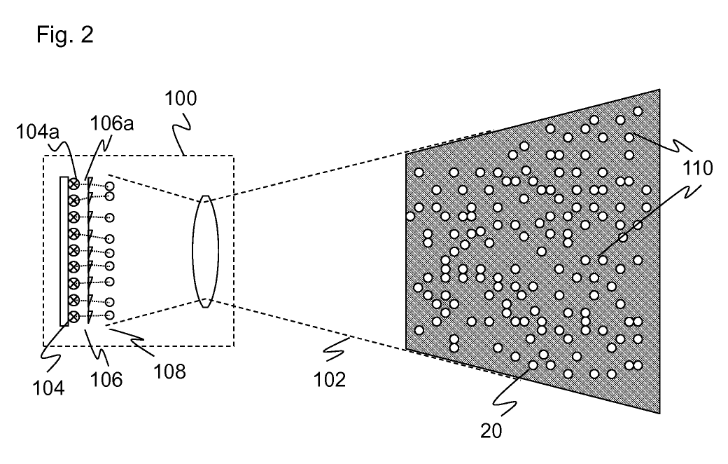

FIG. 2 a schematic sectional view of the illumination unit of the 3D camera in accordance with FIG. 1 with a three-dimensional view of the projection plane of the arising illumination pattern.

FIG. 1 shows in a schematic three-dimensional representation the general structure of a 3D safety camera 10 in accordance with the invention in accordance with the stereo principle which is used for the safety-technical monitoring of a spatial zone 12. The invention will be described for this example of a stereoscopic 3D camera, but also includes other triangulation-based 3D cameras, for instance with only one image sensor and evaluation of the distance-dependent changes in an illumination pattern such as are named by way of example in the introduction. Specifically safety engineering applications are meant by monitoring. It may be the securing of a dangerous machine in that three-dimensional protected zones are defined in the spatial zone 12 which are monitored for unpermitted intrusions by the 3D camera. Other applications are, however, also conceivable with the 3D camera, for example the detection of specific movements which are interpreted as a command to the 3D camera 10 or to a system connected thereto.

Two camera modules are mounted at a known fixed spacing from one another in the 3D camera 10 and each take images of the spatial zone 12. An image sensor 14a, 14b, usually a matrix-type imaging chip, is provided in each camera and takes a rectangular pixel image, for example a CCD or a CMOS sensor. A respective objective having an imaging optics is associated with the image sensors 14a, 14b; it is shown as a lens 16a, 16b and can in practice be realized as any known imaging optics. The viewing angle of these optical systems is shown in FIG. 1 by dashed lines which each form a pyramid of view 18a, 18b.

An illumination unit 100 is shown at the center between the two image sensors 14a, 14b, with this spatial arrangement only to be understood as an example and with the illumination unit equally being able to be arranged asymmetrically or even outside the 3D safety camera 10. The illumination unit 100 generates a structured illumination pattern 20 in an illuminated zone 102 and will be explained in more detail further below in connection with FIG. 2.

A combined evaluation and control unit 22 is associated with the two image sensors 14a, 14b and the lighting unit 100. The structured illumination pattern 20 is generated by means of the control 22 and its structure or intensity is varied as required, and the control 22 receives image data of the image sensors 14a, 14b. A stereoscopic evaluation unit 24 of the control 22 calculates three-dimensional image data (distance image, depth map) of the spatial zone 12 from these image data with the aid of a stereoscopic disparity estimate. The structured illumination pattern 20 in this respect provides a good contrast and an unambiguously associable structure of every image element in the illuminated spatial zone 12.

If the control 22 still recognizes an unpermitted intrusion into a protected zone, a warning is output or a danger source is secured, for example a robot arm or another machine is stopped. Safety-relevant signals, that is above all the switch-off signal, are output via a safety output 26 (OSSD, output signal switching device). This functionality can also be dispensed with in non-safety engineering relevant applications.

It is equally conceivable that the three-dimensional image data are only output as such and further evaluations are carried out externally.

To be suitable for safety engineering applications, the 3D camera 10 is designed as failsafe. This means, among other things, that the 3D camera 10 can test itself in cycles below the required response time; it in particular also recognizes defects of the illumination unit 100 and thus ensures that the illumination pattern 20 is available in an expected minimum intensity and that the safety output 26 is made safe, for example with two channels. The control 22 with the stereoscopic unit 24 is equally also self-reliant, that is it evaluates with two channels or uses algorithms which can test themselves. Such regulations are standardized for generally contactlessly acting protective devices, for example, in EN 61496-1 or in IEC-13849-1. A corresponding standard for safety cameras is under preparation.

FIG. 2 shows a schematic sectional view of the illumination unit 100 with a three-dimensional view of the projection plane of the arising illumination pattern 20. The illumination unit 100 includes a light source 104 which is designed with a plurality of individual emitters 104a arranged in the form of a matrix. A two-dimensional VCSEL array serves for this purpose, for example. Only one row of the matrix arrangement of the individual emitters 104a can be recognized in the sectional view of FIG. 2.

The individual emitters 104a are arranged regularly in a usual commercially available VCSEL array. The arising illumination pattern 20 should, however be irregular, stochastically distributed or non-self similar. A microoptical array 106 having a plurality of microoptics 106a is therefore arranged upstream of the light source 104.

The microoptics 106a are prisms shown purely schematically in this embodiment. Different deflection directions for the respectively associated individual emitters 104a arise by an irregular arrangement of the microoptics 106a. It is also conceivable, alternatively or additionally to design the prisms as different from one another so that they also effect a different deflection at the same relative position with respect to the associated individual emitter 104a. Instead of prisms, other, non-imaging microoptics can also be used, for example by using a transmissive grating.

Due to the different deflection directions, the microoptical array 106 formed as a prism field generates stochastically offset virtual spot images for each individual emitter 104a, said spot images being represented schematically by spot symbols 108 in FIG. 2. The spot symbols 108 therefore form an irregular row. The stochastic offset, however, also relates very analogously to the direction perpendicular to the plane of the paper.

The illumination pattern 20 is projected into the spatial zone 12 with the aid of an imaging objective 108. The imaging objective 108 is a converging lens in the simplest case, but can also have different optical elements or a plurality of optical elements in a known manner. In the illumination pattern 20, each pattern element 110 corresponds to an individual emitter 104a whose transmitted beam was not deflected out of the originally regular arrangement by the non-imaging microoptical array 106. The pattern elements 110 therefore form an irregular illumination pattern 20 in their totality which also imposes the required structure on a structureless scenery and prevents the recognition of limb correspondences by a stereo algorithm. Alternatively to a stereo algorithm, the change of the expected structure of the illumination pattern 20 can be evaluated by objects in the scenery.

The individual emitters 104a can be operated with the same optical output power. The individual pattern elements are then equally bright among one another. In an advantageous further development, however, a deliberate deviation is made from this in that, for example, the individual emitters 104a are controlled using different currents. This can be achieved in that the individual emitters 104a can be controlled individually. Another possibility in which work is carried out with a uniform voltage and an individual control can be dispensed with has different designs of the individual emitters 104a, for instance different resistances in the feed lines due to different line thicknesses or the like. Part regions of the illumination pattern 20 are thus directly brightened or darkened. One application is a marginal regional stereo exaggeration with particularly bright margins of the illumination pattern 20 to compensate a corresponding marginal region drop of the image sensors 14a-b or of the optics 16a-b. Particularly homogeneously illuminated images are thus taken. For this purpose, the individual emitters 104a have a greater current applied in an outer region of the semiconductor array of the light source 104 than in its interior and thus transmit more light.

The illumination pattern 20 can be varied in different variants of the 3D camera 10 by replacing the microoptical array 106. An adaptability without conversion of the 3D camera 10 is possible by an advantageous further development in which the individual emitters 104a are split into two or even more groups. The groups can be controlled individually in this respect so that their respective individual emitters 104a are selectively active or inactive or light up with different brightness. Different illumination patterns 20 can thus be generated by the same illumination unit 100 to adapt to different applications, 3D cameras or sceneries. If a larger number of such groups is formed, the combination system of simultaneously active groups offers versatile variation possibilities. In a borderline case, the individual emitters 104a can even be controlled individually. The general packaging density of the individual emitters 104a can then be selected a little higher than in embodiments without such groups so that the illumination pattern 20 still has the required degree of filling even when some groups are not active.

It is furthermore conceivable to arrange the semiconductor array 104 displaceably with respect to the imaging optics 108. A part region of the semiconductor array 104 which is projected as an illumination pattern 20 is then selected by a corresponding adjustment. An adaptation can also take place in this manner.

1. A 3D camera (10) for monitoring a spatial zone (12), wherein the 3D camera (10) has at least one image sensor (14a-b) for taking image data from the spatial zone (10), an evaluation unit (22, 24) for generating a distance image with three-dimensional image data from the image data of the image sensor (14a-b) and an illumination unit (100) with a light source (104) and an upstream microoptical array (106) with a plurality of microoptics (106a) to illuminate the spatial zone (12) with an irregular illumination pattern (20), wherein the light source (104) has a semiconductor array with a plurality of individual emitters (104a); and wherein the microoptical array (106) has non-imaging microoptics (106a).

2. A 3D camera (10) in accordance with claim 1,
wherein the microoptical array (106) is a microprism array, wherein the non-imaging microoptics (106a) are formed as prisms which deflect the light beams of the individual emitters (104a) in respective different directions.

3. A 3D camera (10) in accordance with claim 2,
wherein the prisms (106a) have a Fresnel structure.

4. A 3D camera (10) in accordance with claim 2,
wherein the prisms (106a) have a mutually different design and thus transmit incident light beams at different deflection angles.

5. A 3D camera (10) in accordance with claim 1,
wherein the microoptics (106a) are arranged irregularly.

6. A 3D camera (10) in accordance with claim 1,
wherein the individual emitters (104a) are arranged irregularly.

7. A 3D camera (10) in accordance with claim 1,
wherein the semiconductor array (104) is a VCSEL array.

8. A 3D camera (10) in accordance with claim 1,
wherein each individual emitter (104a) has a dot-shaped radiation surface, and wherein the pattern element generated by the individual emitter (104a) has the shape of the radiation surface.

9. A 3D camera (10) in accordance with claim 1,
wherein individual emitters (104a) form at least two groups, and wherein a group of individual emitters (104a) can be activated without activating the other groups of individual emitters (104a).

10. A 3D camera (10) in accordance with claim 1,
wherein the individual emitters (104a) can be controlled with mutually different currents.

11. A 3D camera (10) in accordance with claim 10,
wherein individual emitters (104a) in an outer region of the semiconductor array (140) can be controlled by higher currents than individual emitters (104a) in an inner region of the semiconductor array (104).

12. A 3D camera (10) in accordance with claim 1,
wherein the illumination unit (100) has an imaging objective (108) to project the illumination pattern (20) into the spatial zone (12).

13. A 3D camera (10) in accordance with claim 12,
wherein the imaging objective (108) and the semiconductor array (104) are arranged displaceable with respect to one another to image different subsets of individual emitters (104a).

14. A 3D camera in accordance with claim 1,
which is formed as a stereo camera (10), and wherein the evaluation unit (22) has a stereoscopy evaluation unit (24) which is designed for the application of a stereo algorithm in which mutually associated part regions of the images of the spatial zone (12) illuminated by the illumination pattern (20) and taken by the two cameras of the stereo camera (10) are recognized and their distance is calculated with reference to the disparity to generate a three-dimensional distance image.

15. A 3D camera (10) in accordance with claim 1,
which is designed as a safety camera, wherein the evaluation unit (22) is designed to recognize unpermitted intrusions into the spatial zone (12) and thereupon to generate a switch-off signal, and wherein a safety output (26) is provided to output a switch-off signal via it to a monitored machine.

16. A method of monitoring a spatial zone (12), wherein image data are taken from the spatial zone (12) and a distance image using three-dimensional image data is generated from the image data, wherein the spatial zone (12) is illuminated with an irregular illumination pattern (20) by an illumination unit (100) with a light source (104) and by an upstream microoptical array (106) with a plurality of microoptics (106a),
wherein
a corresponding number of individual light beams are transmitted from the light source (104) designed as a semiconductor array with a plurality of individual emitters (104a), said individual light beams being deflected by the microoptical array (106) in a non-imaging manner into the irregular illumination pattern (20).
